(19) United States
(12) Patent Application Publication
(10) Pub. No.: US 2025/0140005 A1
(43) Pub. Date: May 1, 2025

(54) AI ASSISTED VIDEO EDITING TOOL

(71) Applicant: Irad EYAL, Los Angeles, CA (US)

(72) Inventor: Irad EYAL, Los Angeles, CA (US)

(21) Appl. No.: 18/499,409

(22) Filed: Nov. 1, 2023

(51) Int. Cl. G06V 20/70; G06F 16/58; G10L 15/26

(52) U.S. Cl. CPC G06V 20/70; G06F 16/5866; G10L 15/26

(57) ABSTRACT

The present technology provides for AI-assisted video editing tools that implement a novel method of processing video which includes transcribing segments of a video and labeling the segments based on the contents of the segments. A smart edit can be generated based on the labelled segments. The smart edit can serve as a rough cut for a user to make further edits.

### FIELD OF THE INVENTION

The present technology relates to digital media. More particularly, the present technology relates to digital video editing with machine learning based tools.

### BACKGROUND

Today, digital video is one of the most popular media forms. As digital video becomes increasingly prevalent, so too do digital video technologies become increasingly advanced. For example, digital video technologies have advanced to provide users with several tools for video editing. In a conventional video editing system, these tools allow a user to manually make changes to a digital video. For example, the user can make a video clip from the digital video by selecting a starting point for the video clip and selecting an ending point for the video clip. Conventional video editing tools typically require users to make edits manually, which may be confusing, difficult, and inefficient. Thus, there is a need for technological improvements in the field of digital video editing.

### SUMMARY

Various aspects of the present technology can include systems, methods, and non-transitory computer readable media configured to provide AI-assisted video editing tools that implement a novel method of processing video which includes using an AI-based voice-to-text algorithm to transcribe each segment (e.g., section, line, frame) of the video, labeling the segments based on the content of the segment and grouping segments with similarly annotated content. This facilitates the ability for an editor to find the “best” scenes for a topic, among other things.

Another feature of the technology is the ability to generate smart edits which automate what is typically known as rough cuts. Rough cuts are typically done manually in a time consuming process. The process for creating smart edits can include automatically editing the transcript based on specified criteria (e.g., editing to create the most dramatic, engaging script that tells the story of what occurs in the raw footage, regardless of the actual sequence. Then an AI engine can translate the generated script into edit instructions for the edit systems. This enables LLM based algorithms to exercise a creative function, which can be further processed using other natural language processing tools to match the creative script to the best or desired options in the raw transcript.

As one example, the smart edit can include at least some of the following steps: (i) transcribing the footage; (ii) breaking the footage into logical scene beats, focused on single topics of discussion; and (iii) summarizing each beat, with a focus on criteria relevant to the edit (participants, location, important actions). The beat summaries can be included in an annotated transcript for each edit. This is a novel technique not previously known and which provides various advantages as will be apparent from the description herein. For example, this technique facilitates creation of an overview of the scenes which further facilitates the selection of beats to add, remove, or otherwise manipulate. Additionally, the process may include: (i) ranking each beat on criteria (e.g., emotional impact or other criteria); and (ii) selecting beats that best satisfy these or other criteria (e.g., the most interesting beats, the ones that tell the broad story of the raw scene based on their summaries and the criteria rankings or other criteria). As further described herein, this technique facilitates finding and editing the best, most dramatic, and most interesting story from raw footage and furthering that story along its story creation path from raw footage to rough cut, to fine cut, and beyond.

According to other aspects of the invention, the system may further revise the scenes to smooth transitions between beats, remove redundant lines, and/or perform other desired processing. The system may actively assist the user by making decisions, in accordance with user provided guidance, about what is a good story and what is not. Based on the user provided guidance, the system determines the best story elements and assembles the story elements into a story.

According to other novel aspects the system and process is configured to enable iterative editing in a conversational chat application (e.g., based on an LLM). For example, this enables users to type requests in natural language, and the chat application then translates those requests into actionable edits and revise the cut. The following is an example of a sample process:

The user inputs a request like “Add in more about her dating life” or “Cut out the part where they argue about square footage.” Multiple requests can be included in a single prompt. The AI application parses the requests and categorizes them as subtractive edits, additive edits, reorders, or other categories. For subtractive edits and reorders, the system delivers a current transcript of the edited scene along with instructions to make the changes. From there, the AI application delivers a new “creative script” which the system can further process to generate the necessary edits. For additive edits, the system searches all or some of the raw transcript for possibly matching content and then provides the AI application with the current script, new material, and requests, and/or other parameters. The AI application can then process the results to generate edits. Iterative edits may be tracked so that users can easily roll back to previous parent revisions and see descendent revisions of the current edit in a graphical timeline. This too is a unique organization technique for video edits that allows for simple, natural organization of series of edit steps and allows a user to easily roll back or forward through their edit process. Clear notes on the requests that were made at each step can be included. This can automatically help users identify changes, who made them, what changed, and anything else that may be described in other notes. This further enables AI-based navigation to edit sequences so a user can search for a particular cut they remember via natural language requests.

The process described above works for individual scenes or interviews of any length. However, the process may be applied to combining scenes and interviews into entire episodes. Using larger context AI models, the process can train the model with sample scripts of an entire episode, then provide multiple scenes and interview transcripts to generate a script for a complete episode. Using the same tools above, the system can assemble the entire episode from edited scenes and interviews.

Another aspect of the technology enables a similar process that is used for additive edits to search an entire project for beats responsive to a particular query. Using a chat-style interface, users can generate a request (e.g., “All the clips where Matt talks about love,” “All the clips where Mark and Tina argue”) and the AI application reviews the entire corpus of clip data to find related clips. This process uses natural language processing, embeddings for each clip, and a database for organizing and quickly reviewing all of the data about scenes, clips, beats, and individual lines and words.

Another aspect of the technology relates to visual editing. In some aspects, the system relies primarily on transcripts to understand the footage and make edit decisions. This is generally sufficient in some cases (e.g., for reality TV, documentary, and news programming) to get to the rough cut stage. In other cases, it may be desirable to take the edits to the fine cut stage. This may be done, for example, by processing visual information as well. This enables the system to make camera decisions when generating a cut, include b-roll without dialog that is critical to the story, and identify cast reactions among other things. The following is an example of a process for implementing this:

The system may include a light system that functions locally to avoid outputting and uploading large video files for AI processing. Alternatively, this can be done with AI video analysis, in conjunction with insight from the transcript, to identify key video frames. Those include entrances and exits, characters entering or leaving, shot angle changes, facial reactions, establishing shots, cutaways to unique objects, and other key video frames determined based on various rules. The AI application can describe those key frames and record them in the clip data, along with transcripts and other desired information. The AI application can use these key frames to understand the content of the video and make selections of camera angles in a cut among other things. It may also determine when to add dialogue free shots like reactions, cutaways or other shots based on the descriptions of those shots.

More generally, the system can automatically process digital videos and generate digital video clips from the digital videos. Processing a digital video can involve, for example, transcribing the digital video to generate a transcript of spoken words in the digital video. Based on the transcript associated with the digital video, as well as audio waveforms, embeddings, tags, labels, timecodes, metadata, and other information, the digital video can be organized into sections. Each section can be tagged with information describing the section and can be searched based on the information. The sections can be organized into bins of similar or related scenes.

In some aspects of the technology, the system can automatically generate smart edits of scenes of a digital video without user input. The smart edits can provide a user with a “rough cut” or a starting point from which to further edit the digital video as desired. Smart edits of a digital video can be generated based on information, such as a transcript, describing sections of the digital video. Based on the information, sections of the digital video can be organized together into groups (e.g., scenes, beats). Each group can focus on various factors, such as participants, location, and actions, associated with the sections of the digital video. The groups of sections of the digital video can be ranked based on various criteria, such as emotional impact, character relevance, story importance. Based on the rankings of the groups of sections of the digital video, the groups can be organized into a logical sequence, progressing in order of the rankings. Once organized into the logical sequence, these smart edits can be presented to a user along with annotations that include summaries of the various factors and criteria associated with each group and each section of the digital video. These annotations can assist the user in making any further edits to the digital video.

In some aspects of the technology, the system provides for editing of a digital video using a conversational chat model. A user can provide editing requests for editing a digital video. The editing requests can be provided in natural language. The technology provides for translating the editing requests into actionable edits and perform edits to the digital video in accordance with the actionable edits. An editing request can involve additive edits, subtractive edits, and reordering edits. These edits can be reflected in a script that corresponds with the digital video in its current state. For an additive edit, the digital video and associated transcript can be searched for matching content. The digital video can be edited to add the matching content. The script corresponding with the digital video can be updated to include the matching content. For a subtractive edit, the digital video and the corresponding script can be searched for content to be removed. The content can be removed from the digital video, and the corresponding script can be updated accordingly. For a reordering edit, the digital video and the corresponding script can be searched for content to be moved. The content can be moved in accordance with the reordering edit, and the corresponding script can be updated accordingly. As a user makes editing requests, the editing requests can be tracked. The editing requests and associated revisions of a digital video can be provided in a graphical navigation system. The user can roll back the digital video to previous revisions using the graphical navigation system. The user can make additional or alternative edits based on the revisions provided in the graphical navigation system. In this way, the user can easily roll back or roll forward to different revisions of the digital video.

In some aspects of the technology, the system provides for searching a digital video. A search of a digital video can be based on a search query provided by a user. The search query can involve a search for various objects, actions, and concepts depicted in the digital video. The search can involve matching the search query with information associated with sections of the digital video. In some aspects, the search can be based on embeddings, such as text embeddings and visual embeddings, associated with the sections of the digital video.

In some aspects of the technology, the system provides for generating embeddings for a digital video based on machine learning methodologies. For example, a machine learning model can be trained to generate a text embedding for a section of a digital video based on a transcript associated with the section of the digital video. The machine learning model can be trained with training data that includes, for example, instances of transcripts and labels indicating the objects, actions, and concepts described in the transcripts. As another example, a machine learning model can be trained to generate a visual embedding for a section of a digital video based on video frames in the section of the digital video. The machine learning model can be trained with training data that includes, for example, instances of video frames and labels indicating the objects, actions, and concepts depicted in the video frames. Embeddings for a digital video can be mapped to an embedding space where the embeddings can be compared to determine relationships between the embeddings. For example, embeddings that are within a threshold distance (e.g., determined by a nearest neighbor algorithm) in the embedding space can be determined to be embeddings corresponding with similar text, video frames, or sections of digital video. As another example, embeddings that are within a threshold similarity (e.g., determined by a cosine similarity algorithm) in the embedding space can be determined to be embeddings corresponding with similar text, video frames, or sections of digital video.

In some aspects of the technology, the system provides for tuning a machine learning model for a domain based on training data associated with the domain. The training data associated with the domain can include digital video and associated transcripts of the domain. For example, a machine learning model can be tuned to a particular topic based on training data that includes digital video and associated transcripts that depict and include the particular topic. As another example, a machine learning model can be tuned to a particular episode of a show based on training data that includes past episodes of the show.

In some aspects of the technology, the system provides for a data structure for storing information associated with a digital video. For a digital video, a corresponding data structure can store each line of a transcript associated with the digital video as an element of an array. For each line of the transcript, topics, tags, labels, embeddings, metadata, and other information associated with the line of the transcript can be stored in association with the corresponding element of the array.

In some aspects, the technology can be integrated into a video editing system as a plugin. The various functionalities described herein can be provided through or facilitated by the video editing system, integrated with the plugin, in addition to functions provided through the video editing system.

It should be appreciated that many other features, applications, aspects, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system, according to various embodiments of the present technology.

FIGS. 2A-2C illustrate example interfaces, according to various embodiments of the present technology.

FIG. 3 illustrates an example computer system, according to various embodiments of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for AI Assisted Video Editing Tools

As background, digital video is one of the most popular media forms. As digital video becomes increasingly prevalent, so too do digital video technologies become increasingly advanced. For example, digital video technologies have advanced to provide users with several tools for video editing. In a conventional video editing system, these tools allow a user to manually make changes to a digital video. For example, the user can make a video clip from the digital video by selecting a starting point for the video clip and selecting an ending point for the video clip. Conventional video editing tools typically require users to make edits manually, which may be confusing, difficult, and inefficient. Thus, there is a need for technological improvements in the field of digital video editing.

Under conventional approaches, digital video editing tools generally resemble processes performed in traditional film editing. In film editing, shots are selected from raw footage and combined into sequences that ultimately become a final film. The shots are selected by cutting the raw footage into segments. The shots are spliced together and combined into sequences. The sequences are likewise spliced together into the final film. These processes make traditional film editing a confusing, difficult, and inefficient procedure. As conventional digital video editing tools generally resemble these processes, conventional digital video editing tools are likewise confusing, difficult, and inefficient. Furthermore, as digital video becomes increasing prevalent, these challenges arising from conventional digital video editing tools are exacerbated. Thus, conventional approaches fail to address these and other challenges arising in digital media technology.

An improved approach rooted in digital media technology and computer technology overcomes the foregoing and other challenges arising under conventional approaches. The present technology provides for artificial intelligence (AI) assisted video editing tools that implement a novel method of processing video. As a brief overview of the method, the present technology can transcribe a video using an AI-based voice-to-text algorithm. Based on a transcript of the video, video clips depicting logical scene beats that focus on a single topic or concept can be generated from the video. For example, each video clip can depict a scene involving a particular character, discussing a particular topic, demonstrating a particular action, and the like. The present technology can label the video clips based on the contents of the video clips. The labels can describe, for example, topics discussed in dialogue in the video clips, emotions conveyed in the video clips, names of characters depicted in the video clips, names of actors depicted in the video clips, actions performed in the video clips, and other descriptions for the contents of the video clips. The labels can include, for example, embeddings generated based on the video clips. The embeddings can be numerical representations (e.g., vector representations) of portions of the transcript associated with the video clips, numerical representations of images in the video clips, or a combination of different modes (e.g., text and images). The labels for the video clips can facilitate searching, ranking, and editing of the video clips. For example, the present technology can automatically generate a smart edit from the video clips based on the labels for the video clips. The smart edit can be a rough cut of the video from which the video clips were generated. Using the labels for the video clips, the smart edits can organize the video clips in a logical progression based on, for example, a ranking of the video clips by their emotional impact, character relevance, story importance, or other ranking criteria. The resulting smart edit can be useful for a video editor as a basis for further edits. In this regard, the present technology provides tools for further editing a smart edit, or revising any video in general. For example, a user can provide editing requests through a conversational chat model. The present technology can translate the editing requests into actionable edits and perform the edits in accordance with the editing requests. For example, a user can search for video clips related to a particular topic and add, remove, or reorder the video clips. These features, and others relating to the present technology provided herein, provide for intuitive and user-friendly tools for efficient digital video editing and address the shortcomings associated with conventional approaches to digital video editing.

For example, with the present technology, a user can provide raw footage from a video project. In this example, the raw footage can include interviews with a person who discusses various topics. The raw footage can be processed with a voice-to-text algorithm to generate a transcript for the raw footage. Based on the transcript, video clips can be generated from the raw footage. Each video clip can depict, for example, the person discussing a different topic. Each video clip can be labelled with, for example, the topic that the person is discussing in the video clip. Based on the labels for the video clips, a smart edit can be generated for the user. The smart edit can include the video clips organized by topics that the person discusses and sequenced in a logical progression to provide an interesting story. For example, the video clips can be ranked based on their story importance and sequenced so that the video clips with the higher ranked story importance is provided earlier in the smart edit than the video clips with the lower ranked story importance. The smart edit can be provided to the user for review and further editing. For example, the user can enter a command to search for video clips where the person discusses a particular topic. The command can be converted into editing commands through a conversational chat model, and the video clips that satisfy the command can be surfaced for the user. The user can enter another command to add all the video clips where the person discusses the particular topic to the smart edit. The command to add all the video clips can be converted into editing commands through the conversational chat model, and the video clips surfaced to the user can be added to the smart edit. As illustrated in this example, the present technology allows the user to efficiently progress from raw footage to an edited video through use of intuitive and user-friendly tools, thereby avoiding the confusing, difficult, and inefficient shortcomings of conventional approaches to digital video editing. More details relating to the present technology are provided below.

Various aspects of the present technology can be implemented, in part or in whole, as software, hardware, or any combination thereof. In general, functionality as described herein can be associated with software, hardware, or any combination thereof. In some implementations, one or more functions, tasks, and/or operations described herein can be carried out or performed by software routines, software processes, hardware, and/or any combination thereof. In some instances, various aspects of the present technology can be, in part or in whole, implemented as software running on one or more computing devices or systems, such as on a server system or a client computing device. In some instances, various aspects of the present technology can be, in part or in whole, implemented within or configured to operate in conjunction with or be integrated with a server system (or service). Likewise, in some instances, various aspects of the present technology can be, in part or in whole, implemented within or configured to operate in conjunction with or be integrated with a client computing device. For example, the present technology can be implemented as or within a dedicated application (e.g., app), a program, or an applet running on a user computing device or client computing system. The application incorporating or implementing instructions for performing functionality of the present technology can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. Many variations are possible.

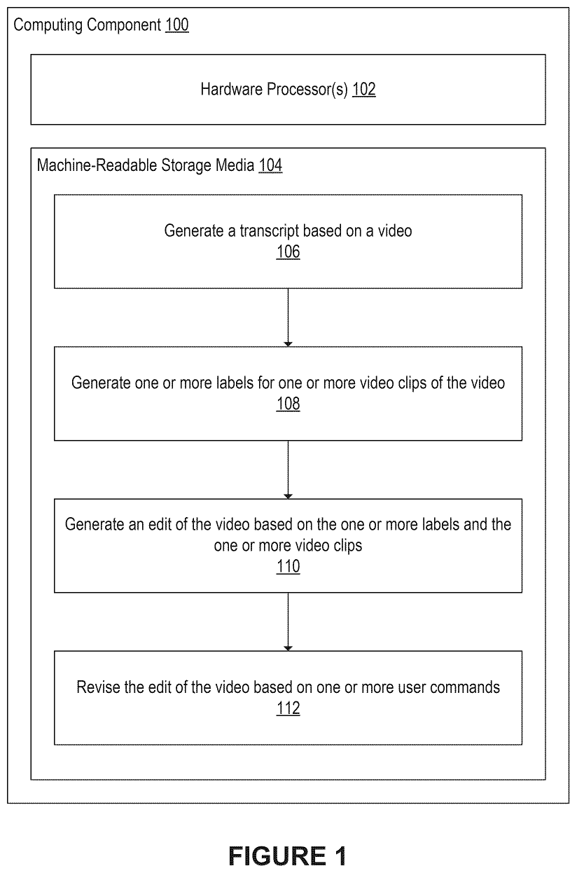

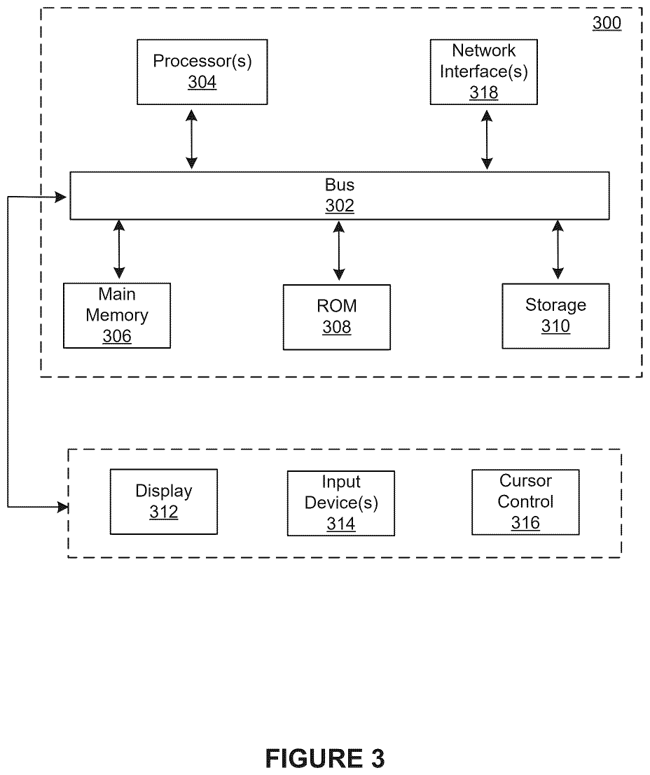

FIG. 1 illustrates a computing component 100 that includes one or more hardware processors 102 and machine-readable storage media 104 storing a set of machine-readable/machine-executable instructions that, when executed, cause the one or more hardware processors 102 to perform an illustrative method for AI-assisted video editing, according to various aspects of the present technology. The computing component 100 may be, for example, the computing system 300 of FIG. 3. The hardware processors 102 may include, for example, the processor(s) 304 of FIG. 3 or any other processing unit described herein. The machine-readable storage media 104 may include the main memory 306, the read-only memory (ROM) 308, the storage 310 of FIG. 3, and/or any other suitable machine-readable storage media described herein.

At block 106, the hardware processor(s) 102 may execute the machine-readable/machine-executable instructions stored in the machine-readable storage media 104 to generate a transcript based on a video. In one aspect of the present technology, a video can be transcribed using an AI voice-to-text algorithm. In some implementations, the AI voice-to-text algorithm can process the video to generate audio data (e.g., audio files, audio samples) corresponding to audio in the video. The audio data can be converted to spectrogram data (e.g., Mel Spectrograms) that capture the audio data in pictorial form. The spectrogram data can be classified, for example by a classifier or other machine learning model, to separate human speech from other audio in the video. The classifier can, for example, compare the spectrogram data with feature maps corresponding with different types of sounds (e.g., human speech, animal sounds, nature sounds, construction sounds) to determine which type of sound is captured in the spectrogram data. Spectrogram data associated with human speech can be further processed, for example by a speech recognition machine learning model, to generate text corresponding with the human speech. The speech recognition machine learning model can, for example, convert the spectrogram data associated with the human speech to frequency coefficients (e.g., Mel Frequency Cepstral Coefficients) that correspond with the frequency ranges at which humans speak. The frequency coefficients can be compared with feature maps corresponding with different sounds (e.g., phonics, letters) associated with human speech to determine sequences of characters captured by the frequency coefficients. The sequences of characters can be converted to text. The text generated by the speech recognition machine learning model can serve as the transcript of the video. While an example AI voice-to-text algorithm is described herein, it should be understood that other algorithms may be used without departing from the various aspects of the present technology.

The transcript of the video can be used alone, or in conjunction with other available data, such as preexisting scripts, audio waveforms, metadata (e.g., timecodes, filenames), to group and synchronize portions of the transcript with video clips of the video. In one aspect of the present technology, video clips are generated based on a video. Each video clip can have a corresponding transcript that includes text of audio spoken in the video clip. In various implementations, the video clips can include various lengths of video. For example, each video clip can correspond with one spoken line of the corresponding transcript. Each video clip can correspond with a single topic of discussion. Various video clips can depict various types of shots, such as establishing shots, cutaways, transition shots, entrances, exits, a character entering, a character leaving, a camera angle change, facial reactions, and the like. Some video clips can be dialogue free and include various actions, such as reactions to dialogue, portrayals of various emotions, characters performing various actions, and the like. Many variations are possible. The video clips can overlap so that a portion of one video clip overlaps, or is included, in another portion of another video clip. For example, a segue between two topics can be included in one video clip as a conclusion to the first of the two topics and included in another video clip as an introduction to the second of the two topics. In one aspect of the present technology, the video clips generated based on the video correspond with logical scene beats. Each video clip is ready to be labeled, sorted, and edited, as further described herein.

For example, the present technology can generate a transcript of raw footage of an interview with a person. In this example, the interview can involve a range of topics including various time periods of the person's life. From the raw footage, the transcript can be generated using an AI voice-to-text algorithm. Based on the transcript, video clips are generated from the raw footage. In this example, the video clips can correspond with topics of discussion in the interview. So, a first video clip can correspond with a first time period of the person's life (e.g., high school). A second video clip can correspond with a second time period of the person's life (e.g., college). A third video clip can correspond with a third time period of the person's life (e.g., first job). The video clips can be associated with portions of the transcript that correspond with the spoken words of the interview in the video clips. These video clips are then ready to be labeled, sorted, and edited.

At block 108, the hardware processor(s) 102 may execute the machine-readable/machine-executable instructions stored in the machine-readable storage media 104 to generate one or more labels for one or more video clips of the video. In one aspect of the present technology, video clips generated from a video can be labelled to identify topics, concepts, emotions, dialogue, characters, actions, locations, and other features depicted in the video clips. Based on the labels for a video clip, the video clip can be summarized with a focus on potentially relevant features in the video clip that may be the subject of searches or edits. In some instances, the labels can be included as part of a summary (e.g., beat summary) associated with the video clips. For example, a video clip can be associated with various labels identifying features depicted in the video clip. The video clip can also be associated with a summary that incorporates the various labels into a brief synopsis of what is depicted in the video clip. In some instances, transcripts associated with the video clips can be annotated based on the labels. For example, a transcript associated with a video clip can be annotated to indicate actions performed during dialogue spoken in the video clip. A line of the dialogue can be annotated to indicate an action that was performed when the line of dialogue was spoken. As another example, a transcript associated with a video clip can be annotated to indicate which lines of a dialogue spoken in the video clip depict a particular emotion, such as funny, sad, dramatic, and angry. The transcript can be annotated to indicate the lines of the dialogue that are introducing a topic, discussing the topic, and providing a conclusion on the topic. Many variations are possible. Based on various labels for a video clip, the present technology can generate a title for the video clip. The title can provide a general description of the video clip based on the labels for the video clip.

In one aspect of the present technology, embeddings can be generated for video clips based on the video clips and transcripts associated with the video clips. In general, an embedding is a numerical representation (e.g., vector representation) of a feature associated with a video clip. The embedding can represent text of a transcript, or of a portion of the transcript. The embedding can represent video, or images, of the video clip. In some instances, the embedding can represent a combination of text and video. Embeddings can be mapped to an embedding space (e.g., vector space) where interrelationships between what the embeddings represent can be determined based on relationships between the embeddings in the embedding space. For example, embeddings determined (e.g., by a nearest neighbor algorithm) to be within a threshold distance of each other can represent text, images, and/or video that are the same or similar. Embeddings determined (e.g., by a cosine similarity algorithm) to be within a threshold similarity of each other can represent text, images, and/or video that are the same or similar. In one aspect of the present technology, embeddings can be generated based on a machine learning model. A machine learning model can be trained based on instances of training data that include labeled text, labeled images, and/or labeled video. An instance of training data can include, for example, an instance of text, an image, and/or a video as well as a label identifying what is depicted or represented by the text, the image, and/or the video. The machine learning model can be trained to generate embedding based on the instances of training data. The machine learning model can be trained so that embeddings generated based on instances of training data with the same or similar labels are within a threshold distance or a threshold similarity of each other when mapped to an embedding space. For example, embeddings generated based on instances of training data with labels of text, images, and/or videos that are more similar to each other can be closer together than embeddings generated based on instances of training data with labels of text, images, and/or videos that are more dissimilar to each other. The trained machine learning model can be applied to text of a transcript, images of a video clip, and/or the video clip to generate embeddings that represent the text, the images, and/or the video of the video clip. The embeddings generated for the video clip can be used to label the video clips, which facilitates searching, ranking, and editing, as further described herein.

In one aspect of the present technology, descriptive materials for video clips, including labels, transcripts, annotated transcripts, summaries, titles, embeddings, and the like, can be stored in a data structure associated with a video from which the video clips were generated. The data structure can include an array with each element of the array corresponding to a line or an action depicted in the video. Each element can be populated with the descriptive material corresponding to the line or the action depicted in the video. For example, a video of a dialogue between two characters can be divided into sections. Each section of the video can include a line of dialogue spoken by either of the two characters or an action (e.g., entering, exiting, reacting, gesturing) performed by either of the two characters. A data structure associated with the video can include an array with each element of the array corresponding to a line of dialogue or an action. For example, an element of the array can correspond with a line spoken by one of the two characters. The element can be populated with labels generated for the line and embeddings generated based on a portion of the video for the line. As illustrated in this example, the data structure provides a readily accessible collection of descriptive material for each part of the video, facilitate efficient search for relevant material during editing.

At block 110, the hardware processor(s) 102 may execute the machine-readable/machine-executable instructions stored in the machine-readable storage media 104 to generate an edit of the video based on the one or more labels and the one or more video clips. In one aspect of the present technology, an edit (e.g., smart edit) of a video can be generated using video clips generated from the video. The edit can be considered a “rough cut” of the video. In general film terms, a rough cut, or rough edit, is an early or initial edited version of a video. In some instances, the rough cut may be ready to be finalized without further edits. In other instances, the rough cut can serve as a starting point for a user to make further edits to finalize the video. In one aspect of the present technology, an edit of a video can be generated based on a script. The script can be generated based on a transcript associated with the video. The script can be generated by a machine learning model trained to generate stories, or scripts, from text material, or transcripts. For example, the machine learning model can be trained based on instances of training data that include existing stories and existing scripts. Based on the instances of training data, the machine learning model can be trained to learn patterns and structures associated with stories and scripts. In some instances, a transcript can be provided to the machine learning model, and the machine learning model can generate a creative script or story using the transcript as a prompt, or input. In some instances, a transcript can be provided to the machine learning model, and the machine learning model can edit the transcript, for example by removing portions of the transcript and reordering portions of the transcript, to fit the transcript into a learned pattern or structure. In some cases, the machine learning model can be tuned to generate stories and scripts within a particular domain. For example, the machine learning model can be tuned based on instances of training data from a particular domain. The domain can include, for example, a subject, a genre, a television series, a director, a production studio, and the like. By tuning the machine learning model to the particular domain, the machine learning model can learn patterns and structures associated with stories and scripts of the particular domain. For example, the machine learning model can be tuned based on episodes of a particular television show. Based on the tuning, the machine learning model can learn patterns and structures that resemble those found in the episodes of the particular television show. The machine learning model can generate stories and scripts that follow those learned patterns and structures based on transcripts.

In one aspect of the present technology, generation of stories and scripts can be based on identification of key video frames in a video. Here, the key video frames can refer to portions of a video that depict critical actions. For example, key video frames can depict entrances by characters, exits by characters, shot angle changes, facial reactions by characters, establishing shots, cutaways to characters, cutaways to objects, transitions, and the like. In some instances, these portions of the video may not include audio. The key video frames in these cases can be identified based on visual analysis (e.g., motion flow analysis, identification of objects and characters) of the video. In some instances, identification of key frames can be identified based on the transcript of the video (e.g., identification of text associated with reactionary shots). The identification of key video frames in the video can facilitate generation of an edit of a video by providing materials to transition from one beat of the video to the next. For example, entrances by characters and exits by characters can be added between story beats to illustrate changes to characters depicted in the story beats.

In one aspect of the present technology, generation of stories and scripts can be based on ranking criteria. Here, portions of a transcript, video clips, and/or portions of a video can be ranked based on ranking criteria. The ranking criteria can include, for example, emotional impact, character relevance, story importance, and the like. The ranking can be performed based on a machine learning model. For example, a machine learning model can be trained based on instances of training data that include labeled text and/or labeled videos. The text and/or videos can be labeled (e.g., by viewers) to indicate a level of emotional impact, character relevance, and/or story importance. The machine learning model can be trained based on the training data to assign scores to text and/or videos to indicate levels of emotional impact, character relevance and/or story importance of the text and/or videos. Portions of a transcript associated with a video, video clips generated from the video, and/or portions of the video can be provided to the machine learning model. The machine learning model can assign scores to the portions of the transcript associated with the video, the video clips generated from the video, and/or the portions of the video to indicate the respective levels of emotional impact, character relevance and/or story importance. Based on the scores assigned to the portions of the transcript associated with the video, the video clips generated from the video, and/or the portions of the video, they can be ranked. For example, the portions of the transcript associated with the video, the video clips generated from the video, and/or the portions of the video with a higher score can be ranked higher, and the portions of the transcript associated with the video, the video clips generated from the video, and/or the portions of the video with a lower score can be ranked lower. Based on the ranking, the generation of stories and scripts can select and order portions of a transcript, video clips, and/or portions of a video. For example, the portions of the transcript, the video clips, and/or the portions of the video that fail to satisfy a threshold ranking can be excluded from the generated story and/or script. The portions of the transcript, the video clips, and/or the portions of the video can be ordered so that the highest ranked are ordered first (e.g., the story begins with the most impactful beat) or so that the highest ranked are ordered last (e.g., the story ends with the most impactful beat). In some cases, the portions of the transcript, the video clips, and/or the portions of the video can be ordered so that the story follows a trajectory of increasing impact, followed by a climax (e.g., highest ranked), and followed by decreasing impact. Many variations are possible.

In some instances, the present technology provides for generating an edit of a video from a script (or story) based on a translation of the script to editing instructions. For example, dialogue in a script can be matched with dialogue in a transcript of a video, and video clips corresponding with the dialogue in the transcript can be provided for an edit of the video. Scene changes in the script can be matched with video clips that depict transition changes and provided for the edit of the video. Video clips that depict entrances of characters and exits of characters can be provided to account for changes in characters performing dialogue in the script. Video clips that depict facial reactions can be provided for portions of the script that are associated with higher emotional impact, character relevance, and/or story importance. Many variations are possible.

At block 112, the hardware processor(s) 102 may execute the machine-readable/machine-executable instructions stored in the machine-readable storage media 104 to revise the edit of the video based on one or more user commands. In one aspect of the present technology, a user can make further edits to an edit of a video by entering commands through a conversational chat model. Commands entered through the conversational chat model can be in a natural language and translated to actionable edits to revise, or make further edits. For example, a user can enter a command in a command line to add more footage regarding a particular topic (e.g., “add in more about her dating life”). The command is parsed and translated by the conversational chat model to an actionable edit (e.g., to insert video clips with labels corresponding with “dating” or “dating life”). The user can enter another command in the command line to remove footage regarding another topic (e.g., “cut out the part where they argue about square footage”). The command is parsed and translated by the conversational chat model to an actionable edit (e.g., to remove video clips with labels corresponding with “argument” or “square footage”). The user can enter commands individually, or the user can enter multiple commands in a single command line, or command prompt. Many variations are possible. In general, edits entered through the conversational chat model can be parsed into additive edits, subtractive edits, and reordering edits. For additive edits to a video, a search can be performed through transcripts, labels, embeddings, and other descriptive materials to identify video clips that satisfy the additive edits. The identified video clips can be provided to revise a script associated with the video. The script can be revised to incorporate the identified video clips. The video can then be revised to incorporate the revisions to the script. For subtractive edits to a video, a search can be performed through a script associated with the video for a portion (e.g., lines) that satisfies the subtractive edits. The script can be revised to remove the identified portion of the script. The video can then be revised to account for the removed portion of the script. For reordering edits to a video, a search can be performed through a script associated with the video for a portion that satisfies the reordering edits. The portion of the script can be moved in accordance with the reordering edits. The video can then be revised to account for the reordering of the script.

In one aspect of the present technology, iterative edits (e.g., additive edits, subtractive edits, reordering edits) to a video can be tracked so that a user can roll back to previous revisions of the video and make changes based on previous revisions of the video. For example, a user can cause a first edit to be performed on a video to generate a first revision of the video. The user can then cause a second edit to be performed on the first revision of the video to generate a second revision of the video. In this example, the user can decide to roll back to the first revision of the video and cause a third edit to be performed on the first revision of the video, as opposed to the second revision of the video, to generate a third revision of the video. As illustrated in this example, the user has performed two edits on the first revision of the video and, if the user chooses, can roll back to the second revision of the video if the third revision of the video is not satisfactory, or roll back to the first revision of the video to perform a fourth edit. Many variations are possible.

In one aspect of the present technology, navigation and search of a video can be performed based on commands through the conversational chat model. For navigation, a command can be entered through the conversational chat model and translated to a navigation action to surface a desired portion of the video to the user. For example, a user can enter a command in a command line to find a portion of a video that is related to a particular topic (e.g., “find the part where they argue about square footage”). The command is parsed and translated by the conversational chat model to a navigation action (e.g., to surface a portion of the video with labels corresponding with “argument” or “square footage”). For search, a command can be entered through the conversational chat model and translated to a search action to surface desired video clips to the user. For example, a user can enter a command in a command line to find video clips that are related to a particular topic (e.g., “find all the clips where Matt talks about love”, “find all the clips where Mark and Tina argue”). The command is parsed and translated by the conversational chat model to a search action (e.g., parse entire corpus of video clips for video clips with labels that satisfy the search command). The video clips that satisfy the command can be surfaced to the user.

It should be understood that the present technology is not limited to commands and, in one aspect of the present technology, a user can edit, navigate, and search through a user interface. For example, a navigation interface can be provided to displays titles of video clips used in a video. A user can navigate to different portions of the video by interacting (e.g., clicking, selecting) the titles in the navigation interface. The user can interact with the title to display lines of a script that correspond with the portion of the video. The user can navigate to a portion of the video corresponding to a particular line by interacting with the line in the navigation interface. A user can perform subtractive edits to the video through the navigation interface. For example, a user can select a title in the navigation interface to delete a portion of the video corresponding to the title. The user can expand a title and select a line within the title to delete a portion of the video corresponding to the line. A user can perform reordering edits to the video through the navigation interface. For example, a user can move a title in the navigation interface to move a portion of the video corresponding to the title. The user can expand a title and move a line within the title to move a portion of the video corresponding to the line. Many variations are possible.

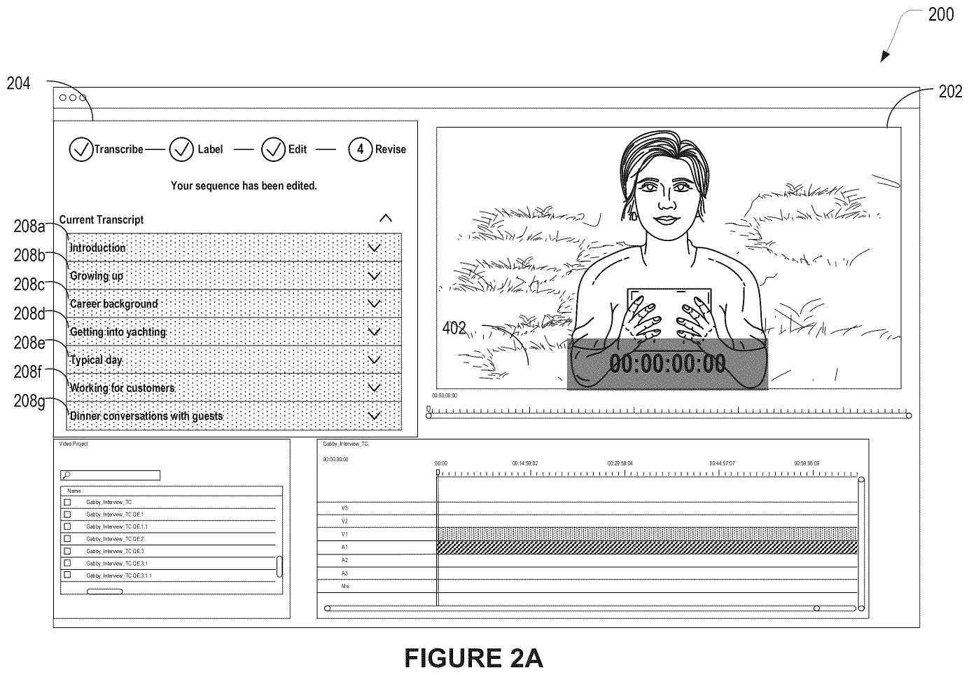

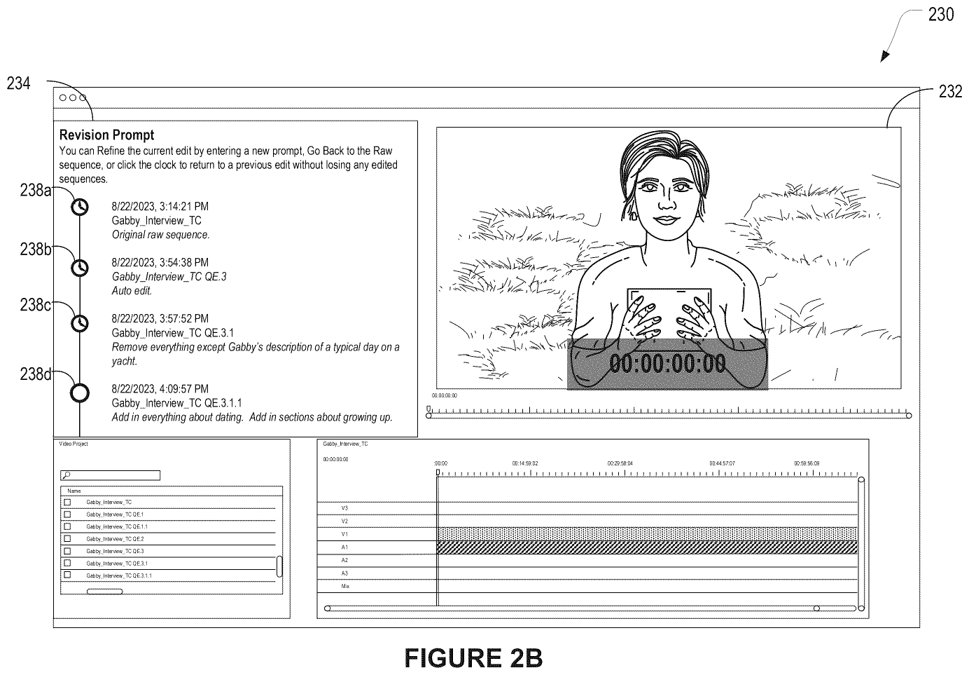

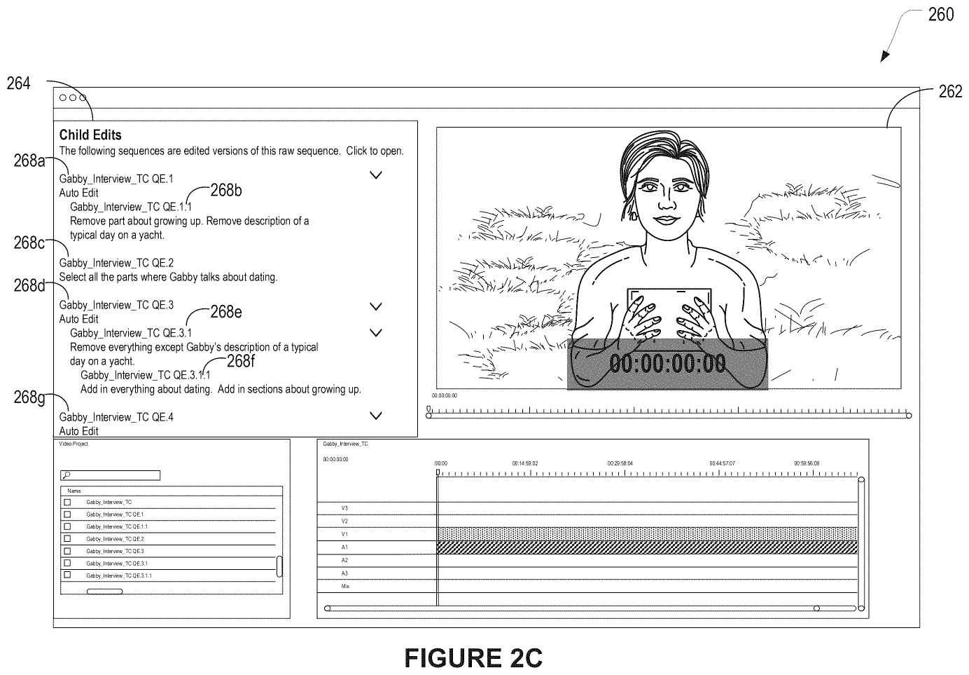

FIGS. 2A-2C illustrate example interfaces, according to various embodiments of the present technology. The example interfaces can be provided in association with one or more functionalities performed by the computing component 100 of FIG. 1. It should be understood that there can be additional, fewer, or alternative steps performed in similar or alternative orders, or in parallel, based on the various features discussed herein unless otherwise stated. All examples herein are provided for illustrative purposes, and there can be many variations and other possibilities.

FIG. 2A illustrates an example interface 200 associated with a smart edit of a video. As illustrated in FIG. 2A, the example interface 200 includes a video preview 202 where the smart edit of the video can be provided for display. The example interface 200 includes a navigation window 204 that can facilitate editing and revising of the video. The navigation window 204 includes a listing of titles 208a, 208b, 208c, 208d, 208e, 208f, 208g associated with portions of the smart edit of the video. A user can navigate to different portions of the video by interacting with the titles 208a, 208b, 208c, 208d, 208e, 208f, 208g. For example, the user can interact with title 208b (“Growing up”) to navigate to a portion of the video describing growing up. The portion of the video describing growing up can be surfaced in the video preview 202.

FIG. 2B illustrates an example interface 230 associated with a smart edit of a video. As illustrated in FIG. 2B, the example interface 230 includes a video preview 232 where the smart edit of the video can be provided for display. The example interface 230 includes a navigation window 234 that can facilitate editing and revising of the video. The navigation window 234 includes a listing of revisions 238a, 238b, 238c, 238d associated with different versions of the smart edit of the video. For example, revision 238a can be associated with an original (e.g., raw) version of the video. Revision 238b can be associated with a first edit (e.g., smart edit) version of the video. Revision 238c can be associated with a second edit version of the video. Revision 238d can be associated with a third edit version and current version of the video. As shown in this example, revision 238c of the video was generated based on a command to “Remove everything except Gabby's description of a typical day on a yacht.” Revision 238d of the video was generated based on a command to “Add in everything about dating. Add in sections about growing up.” A user may choose to roll back to any of the revisions 238a, 238b, 238c, 238d by interacting with the desired revision.

FIG. 2C illustrates an example interface 260 associated with a smart edit of a video. As illustrated in FIG. 2C, the example interface 260 includes a video preview 262 where the smart edit of the video can be provided for display. The example interface 260 includes a navigation window 264 that can facilitate editing and revising of the video. The navigation window 264 includes a listing of revisions 268a, 268b, 268c, 268d, 268e, 268f, 268g associated with different versions of the smart edit of the video. For example, revision 268a can be associated with a first edit (e.g., first smart edit) version of the video. Revision 268b can be associated with a second edit version based on the first edit version of the video. Revision 268d can be associated with a third edit (e.g., second smart edit) version of the video. Revision 268e can be associated with a fourth edit version based on the third edit version of the video. Revision 268f can be associated with a fifth edit version based on the fourth edit version of the video. In this example, a user can choose to roll back to any of the revisions 268a, 268b, 268c, 268d, 268e, 268f, 268g and make further edits based on any of the revisions 268a, 268b, 268c, 268d, 268e, 268f, 268g. This may provide the user with improved flexibility in making various creative choices in editing and preserving those choices after further edits are made.

It is contemplated that there can be many other uses, applications, and/or variations associated with the various embodiments of the present technology. For example, various embodiments of the present technology can learn, improve, and/or be refined over time.

### Hardware Implementation

The foregoing processes and features can be implemented by a wide variety of machine and computer system architectures and in a wide variety of network and computing environments. FIG. 6 illustrates an example computer system 300 in which various features described herein may be implemented. The computer system 300 includes a bus 302 or other communication mechanism for communicating information, one or more hardware processors 304 coupled with bus 302 for processing information. Hardware processor(s) 304 may be, for example, one or more general purpose microprocessors.

The computer system 300 also includes a main memory 306, such as a random-access memory (RAM), cache and/or other dynamic storage devices, coupled to bus 302 for storing information and instructions to be executed by processor 304. Main memory 306 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

The computer system 300 further includes a read only memory (ROM) 308 or other static storage device coupled to bus 302 for storing static information and instructions for processor 304. A storage device 310, such as a magnetic disk, optical disk, or USB thumb drive (Flash drive), etc., is provided and coupled to bus 302 for storing information and instructions.

The computer system 300 may be coupled via bus 302 to a display 312, such as a liquid crystal display (LCD) (or touch screen), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. In some embodiments, the same direction information and command selections as cursor control may be implemented via receiving touches on a touch screen without a cursor.

The computing system 300 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor(s) 304 executing one or more sequences of one or more instructions contained in main memory 306. Such instructions may be read into main memory 306 from another storage medium, such as storage device 310. Execution of the sequences of instructions contained in main memory 306 causes processor(s) 304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 310. Volatile media includes dynamic memory, such as main memory 306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 302. Transmission media can also take the form of acoustic or light waves, such as those generated during radio-wave and infra-red data communications.

The computer system 300 also includes a communication interface 318 coupled to bus 302. Communication interface 318 provides a two-way data communication coupling to one or more network links that are connected to one or more local networks. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN (or WAN component to communicated with a WAN). Wireless links may also be implemented. In any such implementation, communication interface 318 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 700 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in various embodiments,” or the like means that a particular feature, design, structure, or characteristic described in connection with the embodiment is included in at least one embodiment of the technology. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in both method and apparatus modes.

Further, each of the various elements of the invention and claims may also be achieved in a variety of manners. This technology should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the technology of the embodiments of the invention is intended to be illustrative, but not limiting, of the scope of the invention, which is set forth in the following claims.

What is claimed is:

1. A method comprising:
generating a transcript based on a video;
generating one or more labels for one or more video clips of the video;
generating an edit of the video based on the one or more labels and the one or more video clips; and
revising the edit of the video based on one or more user commands.

2. The method of claim 1, further comprising:
synchronizing one or more portions of the transcript with the one or more video clips.

3. The method of claim 1, wherein the one or more labels are generated based on at least one of: a topic, a concept, an emotion, a dialogue, a character, an action, or a location identified in the one or more video clips.

4. The method of claim 1, further comprising:
generating one or more summaries for the one or more video clips based on the one or more labels.

5. The method of claim 1, further comprising:
storing the one or more labels in a data structure associated with the video, wherein the data structure includes an array, and wherein each element of the array corresponds to a line or an action depicted in the video.

6. The method of claim 1, wherein the generating the edit comprises:
ranking the one or more video clips based on ranking criteria; and
ordering the one or more video clips based on the ranking, wherein the generating the edit is based on the ordering.

7. The method of claim 1, wherein the revising the edit comprises:
parsing the one or more user commands for an additive edit;
performing a search to identify a video clip that satisfies the additive edit; and
revising a script associated with the edit of the video based on the video clip, wherein the revising the edit of the video is based on the revised script.

8. The method of claim 1, the revising the edit comprises:
parsing the one or more user commands for a subtractive edit;
performing a search of a script associated with the edit to identify a portion of the script that satisfies the subtractive edit; and
revising the script associated with the edit of the video to remove the identified portion, wherein the revising the edit of the video is based on the revised script.

9. The method of claim 1, further comprising:
tracking iterative edits made to the edit of the video; and
rolling back to one of a plurality of versions of the video based on a user selection.

10. The method of claim 1, further comprising:
performing a search of the one or more video clips for a label that satisfies a search command; and
surfacing a video clip associated with the label that satisfies the search command.

11. A system comprising:
at least one processor; and
a memory storing instructions that, when executed by the at least one processor, cause the system to perform:
generating a transcript based on a video;
generating one or more labels for one or more video clips of the video;
generating an edit of the video based on the one or more labels and the one or more video clips; and
revising the edit of the video based on one or more user commands.

12. The system of claim 11, further comprising:
synchronizing one or more portions of the transcript with the one or more video clips.

13. The system of claim 11, wherein the one or more labels are generated based on at least one of: a topic, a concept, an emotion, a dialogue, a character, an action, or a location identified in the one or more video clips.

14. The system of claim 11, further comprising:
generating one or more summaries for the one or more video clips based on the one or more labels.

15. The system of claim 11, further comprising:
storing the one or more labels in a data structure associated with the video, wherein the data structure includes an array, and wherein each element of the array corresponds to a line or an action depicted in the video.

16. A non-transitory computer-readable storage medium including instructions that, when executed by at least one processor of a computing system, cause the computing system to perform:
generating a transcript based on a video;
generating one or more labels for one or more video clips of the video;
generating an edit of the video based on the one or more labels and the one or more video clips; and
revising the edit of the video based on one or more user commands.

17. The non-transitory computer-readable storage medium of claim 16, further comprising:
synchronizing one or more portions of the transcript with the one or more video clips.

18. The non-transitory computer-readable storage medium of claim 16, wherein the one or more labels are generated based on at least one of: a topic, a concept, an emotion, a dialogue, a character, an action, or a location identified in the one or more video clips.

19. The non-transitory computer-readable storage medium of claim 16, further comprising:
generating one or more summaries for the one or more video clips based on the one or more labels.

20. The non-transitory computer-readable storage medium of claim 16, further comprising:
storing the one or more labels in a data structure associated with the video, wherein the data structure includes an array, and wherein each element of the array corresponds to a line or an action depicted in the video.
